(19) United States
(12) Patent Application Publication
(10) Pub. No.: US 2010/0120596 A1
(43) Pub. Date: May 13, 2010

(54) SEPARATION DEVICE

(75) Inventors: Gunnar Froman, Uppsala (SE); Lars Haneskog, Uppsala (SE); Bjorn A. Johansson, Uppsala (SE); Henrik Ostlin, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE BIO-SCIENCES AB, UPPSALA (SE)

(21) Appl. No.: 12/597,925

(22) PCT Filed: May 8, 2008
(86) PCT No.: PCT/SE08/00318

§ 371 Date: Oct. 28, 2009

(30) Foreign Application Priority Data
May 23, 2007 (SE) 0701250-3

(51) Int. Cl. B04B 13/00

(52) U.S. Cl. 494/8

(57) ABSTRACT

A separation device adapted for separation of a wanted end product from a sample by centrifugation. According to the invention the device comprises: a first, a second and a third compartment; a first fluid connection between the first and second compartments, arranged to be opened and closed by first closing means; a second fluid connection between the second and the third compartments, arranged to be opened and closed by second closing means. The separation device is adapted to be subjected to centrifugation after having been filled with a first density gradient medium in the first compartment, sample in the third compartment and a second density gradient medium or sample in the second compartment, whereby after centrifugation the wanted end product will settle in the second compartment and the first fluid connection and the second fluid connection will be closed by the first closing means and the second closing means respectively.

### CROSS-REFERENCE TO RELATED APPLICATIONS

This application is a filing under 35 U.S.C. §371 and claims priority to international patent application number PCT/SE2008/000318 filed May 8, 2008, published on Nov. 27, 2008, as WO 2008/143570, which claims priority to patent application number 0701250-3 filed in Sweden on May 23, 2007.

### FIELD OF THE INVENTION

The present invention relates to a separation device adapted for separation of a wanted end product from a sample by centrifugation.

### BACKGROUND OF THE INVENTION

The separation of cell containing samples, for example blood, into different fractions by using centrifugation and a density gradient medium has been practised for some time. The principle used is to provide for example a blood sample together with a density gradient medium in a tube and then put the tube into a centrifuge. The density gradient medium is suitably chosen such that after centrifugation red blood cells are collected at the bottom of the tube, below the density gradient medium and the wanted fraction, for example mono nuclear cells, MNCs, will stay at the top of the density gradient medium. The plasma will also be separated and stay above the MNCs. In order to collect the MNCs a pipette is normally used. The pipette is normally manually lowered into the tube such that the open end of the pipette is provided in the MNC band. Thereafter the MNCs are manually drawn up through the pipette. This is a tricky process since only MNCs are wanted. The amount of density gradient media and plasma should be minimised. Such a manual process using centrifugation and a density gradient medium is for example described in: Boyum, A. Isolation of mononuclear cells and granulocytes from human blood. Scand. J. Clin. Lab. Invest. 21, Suppl 97 (Paper IV), 77-89, 1968.

A problem with this method is as described above that the manual handling of the pipette when collecting the MNCs is difficult. The yield and purity of the end product will differ due to variations in the collection.

Another problem is related to the sample application. The sample needs to be applied very carefully on top of the density gradient medium in order not to be mixed with the density gradient medium before centrifugation.

### BRIEF DESCRIPTION OF THE INVENTION

One object of the invention is to provide a separation device that is easy to use and where the wanted end product easily can be retrieved as clean as possible.

This is achieved in a separation device according to claim 1 and in a method according to claim 21. With this device and method it is easy to apply the sample and easy to retrieve the wanted end product. The wanted end product is separated and enclosed such that it can be retrieved easily and as clean as possible.

The closing means are suitably operated automatically, i.e. closed when not subjected to centrifugation and opened when subjected to centrifugation. Hereby the end product will be automatically enclosed inside the second compartment after centrifugation. However manually operated closing means can be preferred in some examples.

Further suitable embodiments are described in the dependent claims.

### BRIEF DESCRIPTION OF THE DRAWINGS

FIG. 1a is a schematic view of a soft bag with three compartments provided in a solid support according to a first embodiment of the invention.

FIG. 1b shows schematically the soft bag of the first embodiment filled with density gradient media and provided with closing means between the compartments in order to prevent mixing.

FIG. 1c shows schematically the soft bag of the first embodiment provided inside a solid support when the sample is applied.

FIG. 1d shows schematically the soft bag of the first embodiment when the closing means have been removed and centrifugation has been performed.

FIG. 1e shows schematically the soft bag of the first embodiment when the closing means have been applied again after the centrifugation.

FIG. 1f shows schematically how the middle compartment, comprising the wanted end product, for example MNCs, has been removed.

FIG. 2a shows schematically a second embodiment of the invention. This is a soft bag provided inside a solid support. The closing means are elastic squeezers.

FIG. 2b shows the second embodiment when the closing means are closed.

FIG. 3a shows schematically a three compartment device according to a third embodiment of the invention before sample application.

FIG. 3b shows schematically the device of the third embodiment of the invention during sample application.

FIG. 3c shows schematically the device of the third embodiment of the invention during low speed centrifugation.

FIG. 3d shows schematically the device of the third embodiment of the invention during high speed centrifugation.

FIG. 3e shows schematically the device of the third embodiment of the invention when the centrifugation has slowed down to a lower level again and the three compartments have been closed.

FIG. 3f shows schematically the device of the third embodiment of the invention when the centrifugation has stopped and the middle compartment has been automatically emptied.

FIG. 3g shows schematically the upper part of the device of the third embodiment of the invention after centrifugation when the upper part of the device has been removed and is emptied into a tube.

FIG. 4 shows schematically a simplified version of the third embodiment. This is called a fourth embodiment of the invention.

FIG. 5a shows schematically a three compartment device according to a fifth embodiment of the invention before sample application.

FIG. 5b shows schematically the three compartment device according to the fifth embodiment of the invention during sample application.

FIG. 5c shows schematically the three compartment device according to the fifth embodiment of the invention when the second closing means has been opened.

FIG. 5d shows schematically the three compartment device according to the fifth embodiment of the invention during centrifugation.

FIG. 5e shows schematically the three compartment device according to the fifth embodiment of the invention after centrifugation when the second closing means has been manually closed again.

FIG. 5f shows schematically the three compartment device according to the fifth embodiment of the invention when a removable bottom part of the second closing means has been removed.

FIG. 5g shows schematically how the middle compartment can be emptied in the fifth embodiment of the invention.

FIG. 5h shows schematically a variant of the fifth embodiment.

FIG. 6a shows schematically a three compartment device according to a sixth embodiment of the invention.

FIG. 6b shows schematically the sixth embodiment of the invention from above.

### DETAILED DESCRIPTION OF THE INVENTION

According to the invention a three compartment device for the separation of a wanted end product from a sample is provided. The sample could be for example a body fluid such as blood or bone marrow, a body tissue, such as adipose tissue or a sample containing cell cultures or cell clusters or cell fragments such as organelles. The wanted end product could be cells of different kinds, such as for example stem cells, mononuclear cells (=MNCs), hematopoetic cells and progenitor cells or cell fragments/organelles such as for example mitochondria, golgie, endoplasmic reticulum and cell nuclei.

One or two density gradient media should be provided inside one or two of the compartments before the centrifugation (if two different density gradient media are used, two compartments are also used for this as will be more closely described below). Density gradient medium used for this type of separation, such as for example ficoll, percoll, sucrose, salt or caesiumchloride, are well known in the art. The density of the medium should be chosen such that at least one fraction of the body fluid will be separated and positioned below the density gradient medium after centrifugation. In the example where blood is separated the red blood cells should preferably be separated and positioned at the bottom of the device, in the lowermost compartment, under the density gradient medium after centrifugation.

The sample is provided inside another one or two of the three compartments before centrifugation. According to this invention either one density gradient medium is provided in the device together with the sample or two different density gradient media are provided. In the case with one density gradient medium the sample should be provided inside the two remaining of the three compartments of the device. In the case with two different density gradient media these should be provided inside one compartment each and the sample should be provided in the third compartment. The two density gradient media should be chosen to have different densities. One of them should preferably have slightly larger density than the wanted end product and the other should preferably have slightly smaller density than the wanted end product. Hereby the wanted end product will be surrounded by density gradient media after centrifugation.

If two different density gradient media are used and blood is the sample that should be separated the density gradient medium with lowest density can preferably be of such composition that the red blood cells do not aggregate. Examples of such density gradient medium are percoll or sucrose. This is to prevent red blood cells from possibly enclosing wanted cells during the aggregation process and thereby decrease yield of the wanted end product. The density gradient medium with higher density can however be of such composition that the red blood cells are aggregating. One example of such a density gradient medium is ficoll.

Further, according to the invention the sizes of the compartments, the amounts of sample and density gradient media and the density of the density gradient media should be chosen such that the wanted end product after centrifugation ends up in the middle compartment. Advantageously the second compartment is smaller than the first and third compartments such that the purity of the wanted end product can be as high as possible when retrieved from the second compartment.

According to the invention the three compartments are in fluid communication during centrifugation and can be either automatically or manually closed after centrifugation. Closing means are hereby provided between the different compartments. The wanted end product can then be retrieved from the middle compartment. Different means for retrieving the end product will be discussed for the different embodiments described below.

The separation device could be a soft bag, for example made of a polymeric material, or a solid device. In the case of a soft bag it should be provided inside a solid support during centrifugation. Different alternatives are further described below.

The first compartment is adjacent to the second compartment. A first fluid connection is provided between the first and second compartments. The first fluid connection is adapted to be closed by first closing means. The second compartment is also adjacent to the third compartment and a second fluid connection is provided between the second and the third compartments. The second fluid connection is adapted to be closed by second closing means.

Said first and second closing means are arranged to close said fluid connections after the centrifugation. This could be either automatically or manually.

In those embodiments using soft bags some kind of squeezers or strings can be used for the closing. They can be provided manually after the centrifugation. It is also possible to melt the fluid connections together by heating them. Another alternative is to provide elastic squeezers that are affected by the forces applied during centrifugation and thereby can be closed and opened automatically. This will be further described below. If the device is provided pre-filled with density gradient media to the user it could also be beneficial if the closing means are provided in a closing position from the beginning. Hereby the application of the sample is simplified and there is no risk of mixing the gradient medium and the sample before the centrifugation.

If the three compartment device instead is a solid device, other kinds of closing means need to be provided. One alternative can be a piston running through the device where the piston is provided with plugs that are designed to close the fluid connections between the compartments for a certain position of the piston and to open the fluid connections for another position of the piston. This will be more closely described below in relation to the third and fourth embodiments of the invention. Actually such a piston with plugs can also be used for soft bags which will be further discussed below.

There are many different possible alternatives for closing the compartments. Some of them are closing and opening automatically in dependence of centrifugation speed. The elastic squeezers were mentioned above. The piston provided with plugs can be connected to a spring that moves the piston when it is compressed during centrifugation. Another alternative closing means that could be operated automatically is an air spring, i.e. a flexible plug having a compartment filled with air. Said plug is closing the fluid connection before and after centrifugation and is compressed to open the fluid connection by the pressure that is applied to the plug during centrifugation from the liquid. This will be more closely described below in connection with the fifth embodiment.

Other closing means that can be operated manually are for example the flexible closing ribbons described for the sixth embodiment or the inner tube that is moved down to close the second fluid connection as described in the fifth embodiment.

These different closing means can be combined in different ways. There are other possible combinations that are covered by this invention than those which are described for the embodiments below.

Another example of a possible closing means that will not be described in relation to any of the embodiments below is a hollow closing ribbon positioned in the fluid connection and adapted to be expanded to close the fluid connection when filled with for example air. This closing ribbon could for example be provided with a bellow/hollow section filled with for example air that is adapted to be compressed manually or automatically to transfer the air to the closing ribbon in order to expand the closing ribbon and close the fluid connection.

The closing means can also be designed as a diaphragm in a camera or as a damper or as some other kind of closable means.

### First Embodiment

### Soft Bag, Manually Operated Closing Means

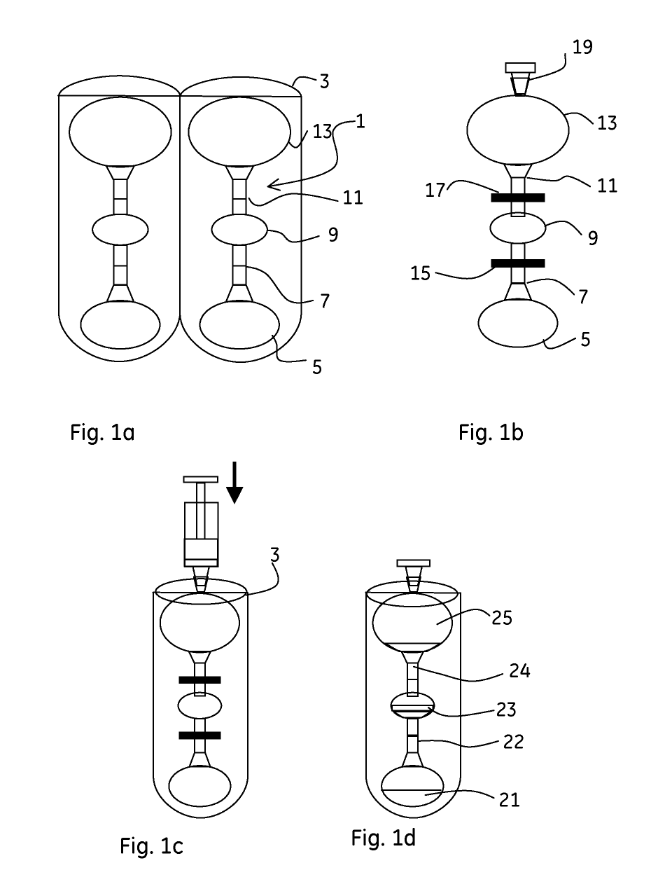

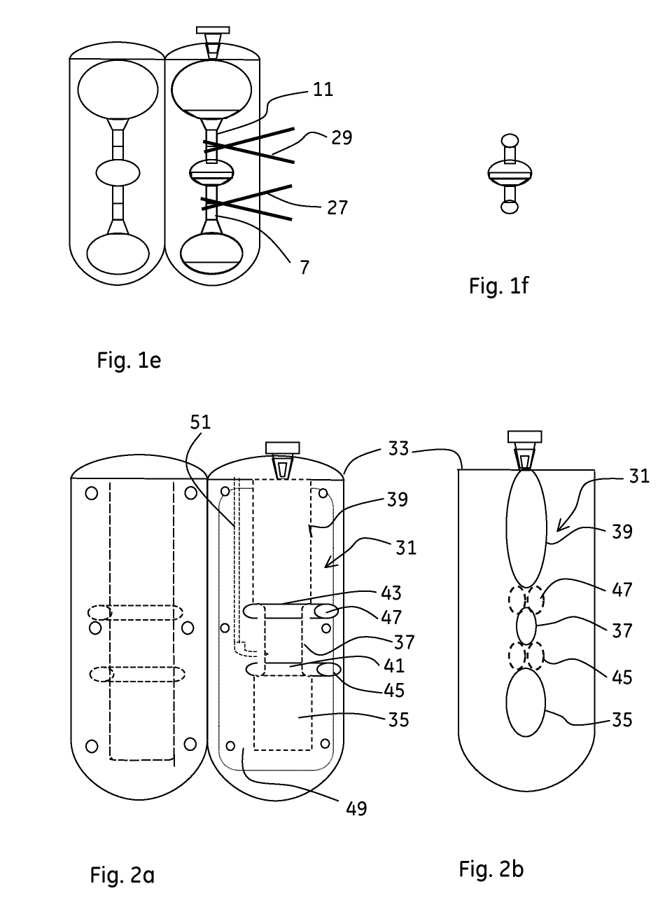

A first embodiment according to the invention is described with reference to FIGS. 1a-1f. In FIG. 1a a soft bag 1 comprising three compartments is shown provided in a solid support 3. The soft bag could for example be made of a polymeric material. This is advantageous because of easy and cheep production and easy handling and distribution to customers. A first compartment 5 is provided with a first fluid connection 7 to a second compartment 9. The second compartment 9 is further provided with a second fluid connection 11 to a third compartment 13.

In FIG. 1b the soft bag 1 is shown provided with a first closing means 15 closing the first fluid connection 7 and a second closing means 17 closing the second fluid connection 11. The third compartment 13 is provided with a luer fitting 19 such that sample can be provided to the third compartment 13. Suitably the first and second compartments 5, 9 are pre filled with two different density gradient media, i.e. two media with different densities. In that case a first density gradient medium is provided in the first compartment 5 and a second density gradient medium with lower density than the first density gradient medium is provided in the second compartment 9.

It is also possible to use only one density gradient medium. In that case only the first compartment should be filled with density gradient medium and both the second and third compartments with sample. The sizes of the three different compartments are crucial for the final location of the wanted end product. Preferably the second compartment is smaller in volume than the first and third compartments. This is because the wanted end product will finally be retrieved from the second compartment and an object of the invention is to retrieve the end product as clean as possible, i.e. mixed with a minimum of other constituents.

In FIG. 1c sample application is shown. In this specific example two different density gradient media were applied to the first and second compartments and sample is applied only to the third compartment. The soft bag is then provided inside the solid support 3 for centrifugation. FIG. 1d shows how different constituents of the sample have been separated into layers after centrifugation. In this example the sample was blood and two different density gradient media were used. One density gradient medium having a density between the densities of the red blood cells and the MNCs (which is the wanted end product in this case) and the other density gradient medium having a density between the densities of the MNCs and the plasma. Hereby red blood cells 21 have been separated and are provided at the bottom of the first compartment 5 below the first density gradient medium 22. MNCs 23 have been separated and are provided in between the first and second density gradient media 22, 24 in the second compartment 9 and the plasma 25 has been separated and is situated above the second density gradient medium 24 in the third compartment 13.

In FIG. 1e the solid support has been opened and the first and second fluid connections 7, 11 are closed by a first closing means 27 and a second closing means 29 respectively. These closing means 27, 29 can be some kind of strings or elastic squeezers that are manually provided.

In FIG. 1f it is shown that the second compartment 9 can be removed from the rest of the device when the MNCs should be retrieved.

### Second Embodiment

### Soft Bag in Solid Support, Automatic Closing Means

In FIGS. 2a and 2b a second embodiment of the invention is shown schematically. In this embodiment a soft bag 31 is provided inside a solid support 33. The soft bag comprises a first, a second and a third compartment 35, 37, 39, a first and a second fluid connection 41, 43 and a first and a second closing means 45, 47 in the same way as described for the first embodiment. However in this embodiment the closing means 45, 47 are elastic squeezers operating automatically, i.e. they are influenced by the centrifugation. The elastic squeezers 45, 47 are closed when not subjected to centrifugation and opens up when the centrifugation speed has come up to a certain level.

In this embodiment it is also shown that the soft bag can be provided with soft fastening sides 49 outside the compartments such that it can be easily secured inside the solid support without damaging the compartments. Furthermore a retrieving tube 51 is shown provided inside the soft bag. This is to simplify the retrieving of the wanted end product from the second compartment. However this retrieving tube 51 is optional. Another possible way of retrieving the end product is simply to take the soft bag out and separate the second compartment from the first and third compartments or to simply provide penetrate the second compartment with a syringe or needle and suck the content out.

This embodiment can of course be used with two different density gradient media. As described above, one of those should then be provided in the first compartment and the other in the second compartment and the sample should be provided in the third compartment. If the soft bag should be delivered to the user pre filled with density gradient media the closing means should preferably be attached and closed during delivery. This makes the sample application easy for the user and the user does not need to do anything to the closing means. The closing means will operate automatically to open during centrifugation and close again when centrifugation is stopped.

If only one density gradient media is used however this should only be applied to the first compartment. The first closing means is suitably provided in closed position before sample application and possibly during delivery to user. The sample should then preferably be applied to both the second and the third compartments. One possibility is that the user can release the second closing means during sample application and put it back before centrifugation. Another alternative is that the second closing means is only provided by the user after sample application. A further alternative would be that both the first and second closing means are provided in closed position to the user. The user then applies sample only to the third compartment and during centrifugation the second closing means is designed such that it opens before the first closing means is opening, i.e. at lower centrifugation speed. Hereby the sample will fill up the second compartment before the first closing means is opening and the actual separation will take place. In this example the third compartment will not be completely filled up with sample because the sample will partly flow into the second compartment and fill the second compartment. However, this would not be a problem in most cases.

### Third Embodiment

### Soft or Solid Compartments, Closing Means Connected to Spring, Automatic Retrieving

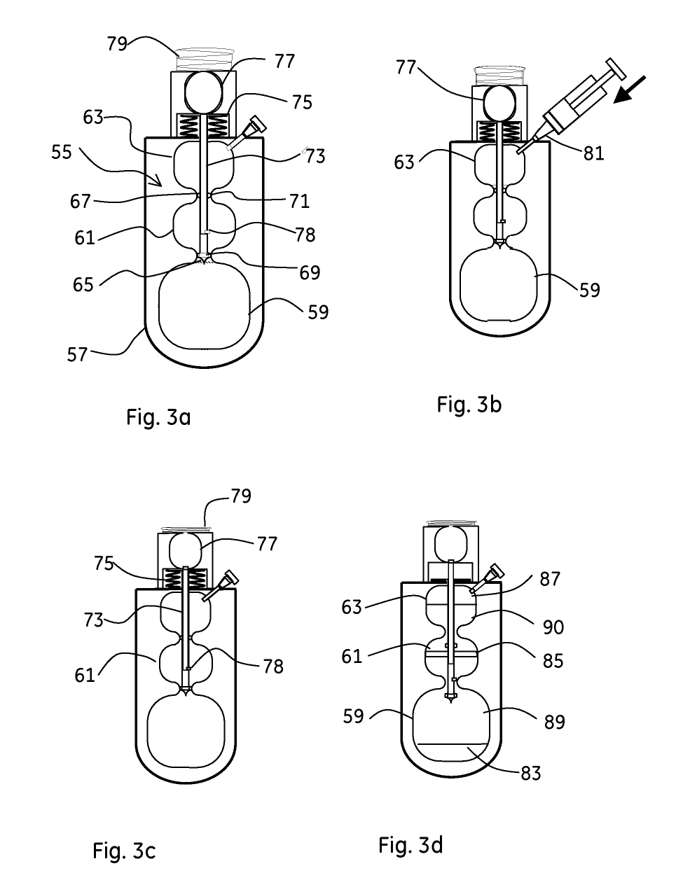

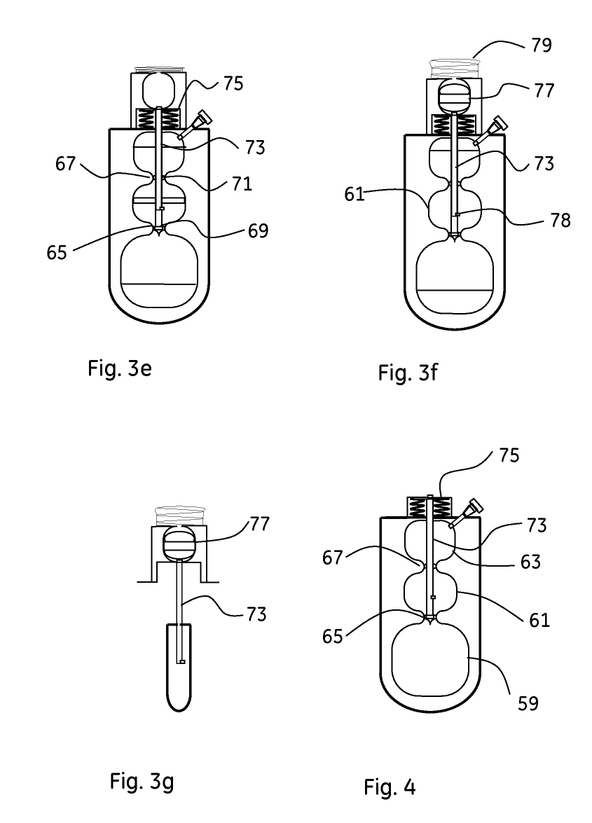

In FIG. 3a a third embodiment of the invention is schematically shown. This could either be a soft bag 55 with three compartments provided inside a solid support 57 or three solid compartments. As in the previous described embodiments a first, a second and a third compartment 59, 61, 63 are provided and a first and a second fluid connection 65, 67 are connecting the compartments in the same way as for the first and second embodiments. A first and a second closing means 69, 71 are also provided for closing the first and second fluid connections respectively as described for the previous embodiments. The closing means 69, 71 are in this embodiment plugs (also called valves) connected to a hollow piston 73 provided running through the compartments and the fluid connections of the device. The plugs 69, 71 are designed such that they close the fluid connections when the piston 73 is in one specific position and opens the fluid connections 65, 67 when the piston 73 is in other positions. The piston 73 is connected to a first spring 75 or some other kind of elastic and springy material that can be affected by centrifugation such that the piston is moved inside the device when the device is subjected to centrifugation.

Furthermore the hollow piston 73 is in fluid communication with a fourth compartment 77 and has an opening 78 into the second compartment 61. The fourth compartment 77 is under influence of a second spring 79 (or a bellow or some other kind of springy material that can be compressed when subjected to centrifugation). The second spring 79 is compressed by at lower centrifugation speed than the first spring 75. This third embodiment of the invention is specifically designed to be used with two different density gradient media and for automatic retrieving of the end product. However, as will be apparent from the fourth embodiment described below this device can be used in a simpler version.

The process when using the device according to the third embodiment will now be described with reference to FIGS. 3b-3g:

In FIG. 3b a sample is applied to the third compartment 63 through a luer fitting 81 provided to the third compartment. A first density gradient medium has already been provided to the first compartment 59 and a second density gradient medium having a lower density than the first density gradient medium has been provided inside the fourth compartment 77. The piston 73 is provided in a closing position, i.e. the closing means 69, 71 are closing the fluid connections 65, 67.

In FIG. 3c the device has been placed in a centrifuge and the centrifugation speed is increasing. The second spring 79 is softer than the first spring 75 and is compressed before the first spring is compressed. When the second spring 79 has been compressed due to the centrifugation the content of the fourth compartment, i.e. the second density gradient medium is pressed down through the hollow piston 73 and through the opening 78 out into the second compartment 61.

In FIG. 3d the centrifugation speed has increased such that also the first spring 75 is compressed. The first spring 75 is connected to the piston 73 such that the piston 73 is moved inside the compartments and the closing means 69, 71 are displaced such that the fluid connections 65, 67 now are open. Under centrifugation the sample and the two density gradient media are now connected and separated inside the three compartments. In the case of a blood sample, red blood cells 83 are positioned at the bottom of the first compartment 59, MNCs 85 are positioned in one band in the second compartment 61 and plasma 87 is positioned in the third compartment 63. The first density gradient medium 89 will in this example be positioned between the red blood cells 83 and the MNCs 85 since the density was chosen so and the second density gradient medium 90 will be positioned between the MNCs 85 and the plasma 87 since that density was chosen such.

In FIG. 3e the centrifugation is slowed down and the first spring 75 will first return to its original position. Hereby the piston 73 is also returned to its original position and thereby the closing means 69, 71 are closing the fluid connections 65, 67.

In FIG. 3f the centrifugation is stopped and also the second spring 79 will return to original position. Hereby the content of the second compartment will be sucked up through the opening 78 of the piston 73 and into the fourth compartment 77.

In FIG. 3g it is shown how easily the fourth compartment can be removed and the content of the fourth compartment can be emptied in a tube through the piston 73. The wanted end product, MNCs in the example of blood, is thereby easily provided in a tube. The sizes of the three compartments can suitably be designed such that a minimum of other constituents will be provided together with the wanted end product in the second compartment (and in the third embodiment finally in the fourth compartment). In this example were two different density gradient media are used the wanted end product will only be provided together with density gradient media in the second compartment after centrifugation. This could be an advantage if other constituents from the sample should be avoided during the retrieving of the end product.

### Fourth Embodiment

### Simplified Version of Third Embodiment

In FIG. 4 a fourth embodiment of the invention is schematically illustrated. Here it is shown that parts of the third embodiment can be used on its own. The second spring and the fourth compartment need not to be used. All other details are the same as in the third embodiment and will therefore not be described here. The different parts are also given the same reference numbers as for the third embodiment.

In the fourth embodiment a first gradient medium is provided inside the first compartment, a second gradient medium is provided inside the second compartment 61 and the sample is provided to the third compartment before centrifugation (alternatively, if only one density gradient medium is used, the first compartment is filled with this density gradient medium and both the second and third compartments are filled with sample). During centrifugation the first spring 75 is compressed and the piston 73 is hereby moved down such that the fluid connections are opened and the sample and gradient media can be connected and separated as described above. After centrifugation the fluid connections are closed again and the wanted end product is provided inside the second compartment 61. Now the end product can be retrieved through the hollow piston 73. Another alternative for retrieving the end product could be directly through the second compartment wall by the using of for example a septa and a needle.

### Fifth Embodiment

### Three Solid Compartments, One Automatic First Closing Means and a Manually Operated Second Closing Means

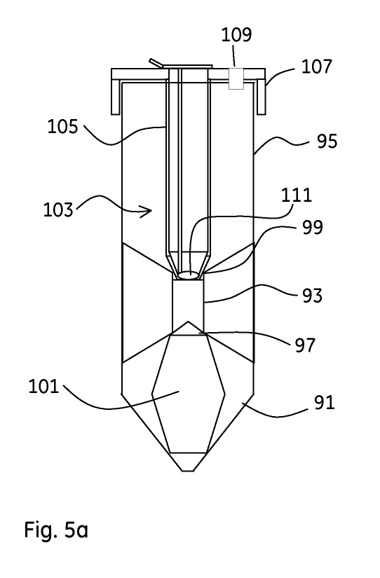

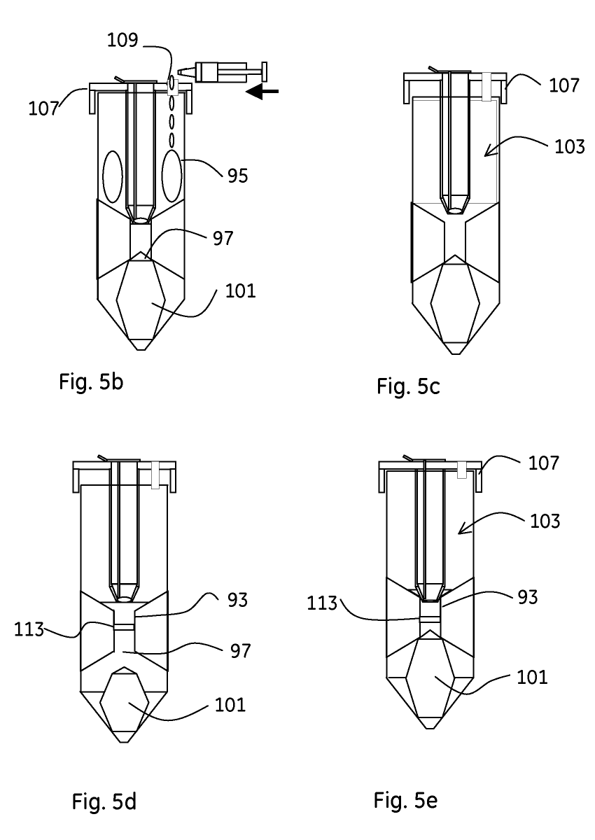

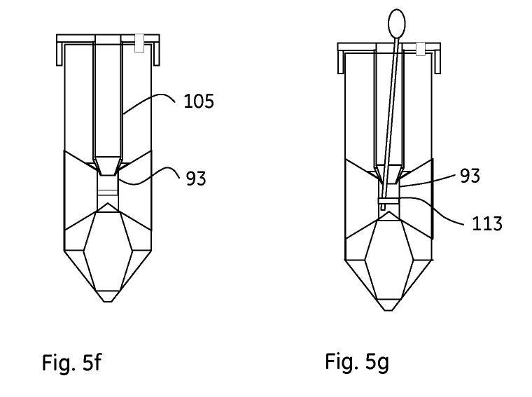

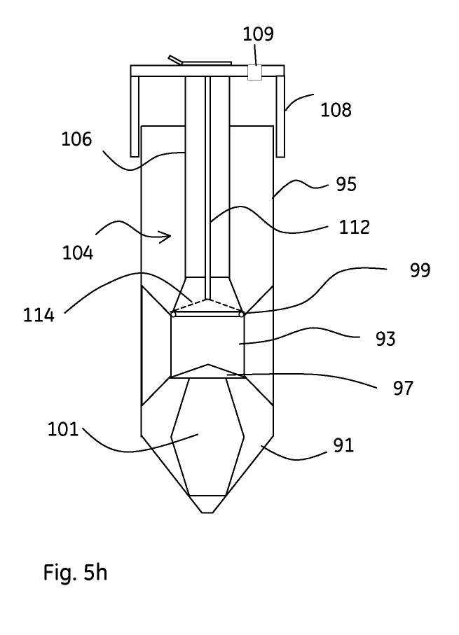

In FIG. 5a a fifth embodiment of the invention is schematically shown. This embodiment comprises three solid compartments, a first compartment 91, a second compartment 93 and a third compartment 95. The second compartment 93 has a smaller volume than the first and third compartments 91 and 95. A first and a second fluid connection 97, 99 are provided between the compartments in the same way as described in the previous embodiments. A first and a second closing means 101, 103 are provided to close or open said fluid connections respectively as also described for the previous embodiments. The first closing means 101 is in this embodiment shown to be an air spring provided inside the first compartment 91. The air spring 101 is designed and positioned such that it closes the first fluid connection 97 when the device not is subjected to any centrifugation and opens the first fluid connection 97 when the device is subjected to a centrifugation speed over a certain threshold value. The air spring is a flexible plug made of elastic material and having a compartment filled with air. Said plug is closing the fluid connection before and after centrifugation and is compressed to open the fluid connection by the pressure that is applied to the plug during centrifugation from the surrounding sample and density gradient media.

The second closing means 103 comprises in this embodiment a hollow tube 105 connected to a cap 107. Said tube can be positioned in at least two positions, one first position where the tube 105 is pressed down to close the second fluid connection 99 and a second position where the tube 105 is lifted up to open the second fluid connection 99. This would be an axial movement of the tube to open and close the second fluid connection. The cap 107 could for example be a threaded cap and it can be designed to take different positions onto the third compartment in order to allow the tube to take its first and second positions. The dimensions of the second fluid connection 99 and the hollow tube 105 are adapted such that the second fluid connection 99 is properly closed by the hollow tube 105 when the tube is in its first position. The operating of the cap and tube is suitable done manually.

The cap 107 is provided with an opening 109 for sample application. Furthermore the hollow tube 105 is preferably provided with a removable bottom part 111 such that the tube 105 can be opened in the bottom after centrifugation for retrieving of the content inside the second compartment 93.

This device can be used both with one density gradient medium and with two different density gradient media. If only one density gradient medium is used this should be provided only in the first compartment 91 and sample should be provided both to the second and third compartments. This is easily achieved by opening the second closing means manually before applying the sample. If two different density gradient media are used the one with higher density should as described for the previous embodiments be provided to the first compartment and the medium with lower density to the second compartment 93. In this case the second closing means should preferably be closed during sample application in order to prevent mixing before centrifugation. The process for using the fifth embodiment of the invention will now be more closely described with reference to the FIGS. 5b-5g.

In FIG. 5b it is shown how the sample is applied through the opening 109 in the cap 107. In this shown example the second closing means is closed during sample application such that only the third compartment 95 is filled with sample. Hereby two different density gradient media were also used in this specific example. The device was hereby pre-filled with a first density gradient medium in the first compartment and a second density gradient medium having a lower density than the first medium in the second compartment. The first closing means 101 is here shown to be closed, i.e. closing the first fluid connection 97.

In FIG. 5c the device is prepared for centrifugation by manually open the second closing means 103, i.e. lifting or screwing the cap 107 up such that the hollow tube 105 takes it's second position.

In FIG. 5d the device has been placed inside a centrifuge and centrifugation has started. Hereby also the first closing means 101 is opened. The first closing means 101 is compressed when subjected to centrifugation such that the first fluid connection 97 now is open. The two density gradient media and the sample are connected and then separating as described for the previous embodiments. The wanted end product is finally positioned as a band 113 in the second compartment 93. In the example were blood is the sample and MNCs is the wanted end product this band 113 comprises MNCs.

When the separation has been completed the centrifugation is stopped. In FIG. 5e is shown how the first closing means has gone back to its original closing position, i.e. closing the first fluid connection 97. Also the second closing means 103 has been taken back to its closing position. This is however done manually by putting down the cap 107 onto the third compartment such that the hollow tube 105 is provided in it's first position. Hereby the second compartment 93 is isolated and the wanted end product 113 is kept inside.

In FIG. 5f it is shown how the removable bottom part 111 in the hollow tube 105 has been removed such that it now is an open passage into the second compartment for retrieving of the end product.

In FIG. 5g it is illustrated how the end product 113 easily can be retrieved through the hollow tube 105 from the second compartment 93.

In FIG. 5h a variant of the fifth embodiment is shown. Parts that are very similar to those in the fifth embodiment are given the same reference numbers, such as the first compartment 91, the second compartment 93, the third compartment 95, the first fluid connection 97, the second fluid connection 99, the first closing means 101 and the opening 109 in the cap. However, the parts that have been modified are given new reference numbers, i.e. the second closing means 104, comprising a hollow tube 106 and a cap 108. In this modified fifth embodiment the hollow tube 106 is designed such that it can be lowered into the second compartment 93. The cap 108 needs then also to be modified somewhat to enable the tube 106 to be moved a longer distance than in the fifth embodiment described above. The hollow tube 106 is furthermore designed such that the content of the second compartment 93 is pressed into the hollow tube 106 when the tube 106 is lowered into the second compartment 93. This will make the retrieving of the end product easy. As indicated in FIG. 5h the hollow tube 106 has preferably a smaller inner diameter, defining an open inner tube 112 such that the end-product is being pressed up through this open inner tube 112 when the hollow tube 106 is lowered down into the second compartment 93. The bottom of the hollow tube 106 can suitably also be designed as indicated in FIG. 5h with a funnel 114 for capturing the end product being pressed up through the hollow tube 106 and direct it to the open inner tube 112 of the hollow tube 106.

Furthermore it could be suitable to provide a seal in the bottom of the hollow tube to seal the opening to the second compartment during centrifugation. This seal should be easy to remove after centrifugation. It could also be suitable to provide some kind of luer fitting to the top of the hollow tube 106 such that a syringe can be attached for retrieving the end product in an easy way. A gasket should also preferably be provided where the hollow tube 106 contacts the second compartment such that the second fluid connection 99 is sealed appropriately when the hollow tube is lowered down into the second compartment.

With this design according to the variant of the fifth embodiment it will be easy to discard maybe the first and/or the last portion retrieved from the second compartment 93 in order to only retrieve the wanted end product. The wanted end product will be positioned somewhere within the second compartment after centrifugation but surrounded by for example density gradient media and it would be advantageous to be able to choose to only retrieve the actual wanted end product in an easy way.

### Sixth Embodiment

### Solid Compartments, Manually Operated Closing Means in Form of Flexible Closing Ribbons

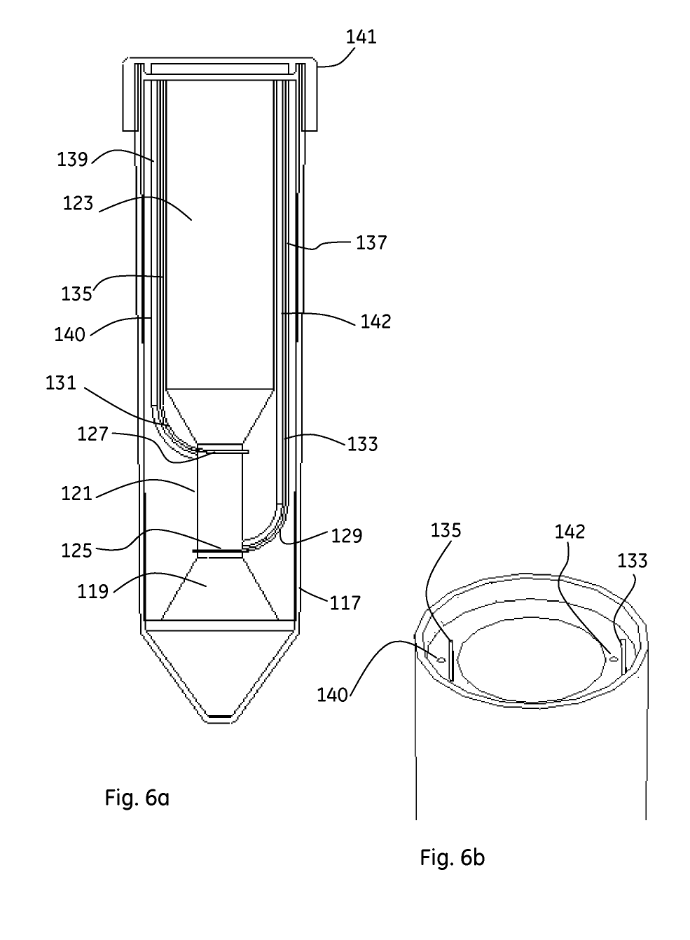

In FIGS. 6a and 6b a sixth embodiment of the invention is shown schematically. In this embodiment the three compartments are solid. The device is preferably provided inside a protecting tube 117 that is suitable for standard centrifugation bucket.

The device according to the sixth embodiment comprises a first compartment 119, a second compartment 121 and a third compartment 123. Between the first and the second compartments is provided a first fluid connection 125 and between the second and third compartments is provided a second fluid connection 127 in the same way as described for the previous embodiments. A first closing means 129 is provided for closing and opening the first fluid connection 125 and a second closing means 131 is provided for closing and opening the second fluid connection 127. The first and second closing means 129, 131 are both manually operated such that the second compartment 121 can be closed and opened in relation to the first and third compartments whenever the operator finds it suitable. The first and the second closing means 129, 131 comprise in this embodiment each a flexible closing ribbon 133, 135 that can be operated from the top of the device as shown in FIG. 6b. The flexible closing ribbons 133, 135 are provided inside guiding channels 137, 139 provided from the top of the device and down to the first and second fluid connections respectively. The flexible closing ribbons 133, 135 cover the fluid connections 125, 127 when provided in closing position, i.e. inserted as far as possible inside the guiding channels 137, 139 and can easily be positioned in a non closing position by an operator by just grabbing the flexible closing ribbons 133, 135 from the top of the device and pull them upwards in the guiding channels 137, 139.

Furthermore an air inlet hole 140 is provided into the second compartment 121 just below the second closing means 131. The air inlet hole 140 runs beside the second closing means 131 all the way up to the top of the device, see FIG. 6b. The reason for providing this air inlet hole 140 is to be able to after centrifugation retrieve the end product from the second compartment. A sample retrieving hole 142 is also provided into the second compartment just above the first closing means 129. The sample retrieving hole 142 runs beside the first closing means 129 the whole way up to the top of the device, see FIG. 6b.

The device according to the sixth embodiment of the invention can of course be used both for one single density gradient medium or for two different. If only one density gradient medium is used this can be pre-filled in the first compartment 119. Then sample should be applied to both the second and the third compartments 121, 123. This is easily done by opening the second closing means when sample is applied from the top. A cap 141 is preferably also provided in order to close the third compartment during centrifugation. This cap 141 is thus simply opened during sample application.

If two different density gradient media are used a first one is provided, possibly previous to delivery of the device, to the first compartment 119 and a second one with lower density than the first one is provided, possibly previous to the delivery of the device, to the second compartment 121. In this case both the first and second closing means 129, 131 are preferably closed during sample application such that the sample and media are not mixed before centrifugation. When two different density gradient media are used only the third compartment 123 is filled with sample. After centrifugation the wanted end product will be positioned inside the second compartment 121 and can be retrieved through the sample retrieving hole 142 from the top of the device.

The sixth embodiment can easily be modified by providing more closing means positioned in different positions along the height of the second compartment. This is suitable since in this case different closing means can be chosen to be closing the second compartment and the second compartment can be chosen to have different volume and different positions. Hereby the purity of the retrieved end product can be enhanced by choosing appropriate closing means to close the second compartment. The final position of the wanted end product can differ somewhat depending on the composition of the sample and the amount of the sample and therefore this method with a varying second compartment is suitable.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A separation device adapted for separation of a wanted end product from a sample by centrifugation, comprising:
a first, a second and a third compartment, where the first compartment (5; 35; 59; 91; 119) is adjacent to the second compartment (9; 37; 61; 93; 121) and a first fluid connection (7; 41; 65; 97; 125) is provided between the first and second compartments, which first fluid connection is arranged to be opened and closed by first closing means (15; 45; 69; 101; 129) and the second compartment is also adjacent to the third compartment (13; 39; 63; 95; 123) and a second fluid connection (11; 43; 67; 99; 127) is provided between the second and the third compartments, which second fluid connection is arranged to be opened and closed by second closing means (17; 47; 71; 103; 131),
said separation device being adapted to be filled with a first density gradient medium in the first compartment (5; 35; 59; 91; 119), sample in the third compartment (13; 39; 63; 95; 123) and sample or a second density gradient medium in the second compartment (9; 37; 61; 93; 121) and said separation device being adapted to be subjected to centrifugation after having been filled accordingly,
the density of the first and possibly the second density gradient medium and the sizes of said three compartments being arranged such that the wanted end product after centrifugation will settle in the second compartment (9; 37; 61; 93; 121),
said first fluid connection (7; 41; 65; 97; 125) and said second fluid connection (11; 43; 67; 99; 127) being adapted to be closed by said first closing means (15; 45; 69; 101; 129) and said second closing means (17; 47; 71; 103; 131) respectively after said separation device has been centrifuged and the wanted end product has been settled in the second compartment.

2. The separation device of claim 1, wherein said device is adapted for separation of cells or cell fragments from a cell or cell fragment containing sample.

3. The separation device of claim 1, wherein said device is adapted for separation of cells from body fluids or body tissues.

4. The separation device of claim 1, wherein said device is pre-filled with a density gradient medium in the first compartment (5; 35; 59; 91; 119) and the first closing means (15; 45; 69; 101; 129) is provided in closing position during delivery to a customer.

5. The separation device of claim 4, wherein the second compartment (9; 37; 61; 93; 121) is pre-filled with a second density gradient medium and also the second closing means (17; 47; 71; 103; 131) is provided in closing position during delivery to a customer

6. The separation device of claim 1, wherein the first and/or second closing means (15, 17; 103; 129, 131) are adapted to be operated manually.

7. The separation device of claim 1, wherein the first and/or second closing means (45, 47; 69, 71; 101) are adapted to be operated automatically, i.e. original position closed and opening when subjected to centrifugation over a certain specified centrifugation speed.

8. The separation device of claim 1, wherein the three compartments (5, 9, 13; 35, 37, 39; 59, 61, 63) are provided in an elastic material, the elastic compartments are then arranged to be positioned inside a solid shell (3; 33; 57) during centrifugation.

9. The separation device of claim 8, wherein the first and/or second closing means (15, 17) are strings that can be manually operated to close the first and/or second fluid connections (7, 11) respectively.

10. The separation device of claim 8, wherein the first and/or second closing means (45, 47) are automatically operated elastic squeezers that have a closed original position and are automatically opened when the device is subjected to a centrifugation speed over a certain level.

11. The separation device of claim 1, wherein the three compartments (59, 61, 63; 91, 93, 95; 119, 121, 123) are made up of solid material.

12. The separation device of claim 1, wherein the first and/or second closing means (101) are automatically operated air springs, comprising a hollow, elastic plug filled with air, said air spring having an original position, when not subjected to centrifugation, closing the fluid connection (97) and being designed to be compressed by liquid pressure built up during centrifugation and opens thus the fluid connection when the device is subjected to a centrifugation speed over a certain level.

13. The separation device of claim 1, wherein the second closing means (103) comprises a hollow tube (105) with a removable bottom part (111), said hollow tube (105) being manually positioned to close or open the second fluid connection (99) and said removable bottom part (111) being adapted to be removed after centrifugation such that the content of the second compartment can be retrieved through the hollow tube (105).

14. The separation device of claim 1, wherein the first and/or second closing means (129, 131) are flexible closing ribbons (133, 135) that can be positioned manually from outside the device to close or open the respective fluid connections (125, 127).

15. The separation device of claim 1, wherein the first and/or second closing means is a plug (69, 71) attached to a piston (73) that is running through the third compartment (63) and the second fluid connection (67) and possibly also through the second compartment (61) and the first fluid connection (65), said piston (73) being manually or automatically operated to change position inside the device and thus place the plugs (69, 71) into different positions closing or opening the respective fluid connections (65, 67).

16. The separation device of claim 15, wherein the piston (73) is connected to a spring (75) outside the three compartments that is compressed during centrifugation and thus moves the piston (73) when the device is subjected to a centrifugation speed over a certain predefined level.

17. The separation device of claim 16, wherein the piston (73) is hollow and used for emptying the content of the second compartment (61) after centrifugation.

18. The separation device of claim 16, wherein the piston (73) is hollow and a fourth compartment (77) is provided in connection to the piston, said piston further having an opening (78) into the second compartment (61), said fourth compartment (77) further being influenced by a second spring (79) being compressed when subjected to lower centrifugation speeds than the first spring (75) that is connected to the piston (73), said fourth compartment (77) being adapted to be filled with a second density gradient medium before centrifugation and is adapted to be automatically emptied into the second compartment (61) before said first spring (75) is compressed during a centrifugation of increasing speed.

19. The separation device of claim 18, wherein said hollow piston (73) and said second spring (79) are adapted to automatically emptying the content of the second compartment (61) into the fourth compartment (77) after separation has been performed and centrifugation speed is slowing down and the second spring (79) is released thereby applying a sucking force through the hollow piston into the second compartment.

20. The separation device of claim 1, wherein the second compartment (9; 37; 61; 93; 121) has a smaller volume than the first and third compartments (5, 13; 35, 39; 59, 63; 91, 95; 119, 123).

21. A method for separating a wanted end product from a sample in a separation device according to claim 1, comprising the steps of:
filling the first compartment (5; 35; 59; 91; 119) with a first density gradient medium;
filling the third compartment (13; 39; 63; 95; 123) with sample;
filling the second compartment (9; 37; 61; 93; 121) with either sample or a second density gradient medium having lower density than the first density gradient medium;
subjecting said separation device to centrifugation, whereby a layer of the wanted end product will be provided inside the second compartment (9; 37; 61; 93; 121);
stopping the centrifugation;
closing the first and second fluid connections (7, 11; 41, 43; 65, 67; 97, 99; 125, 127) either manually or automatically;
removing the wanted end product from the second compartment.
